(19) United States
(12) Patent Application Publication
(10) Pub. No.: US 2014/0120276 A1
(43) Pub. Date: May 1, 2014

(54) Corrosion Resistance When Using Chelating Agents in Chromium-Containing Equipment

(71) Applicants: Cornelia Adriana De Wolf, Eerbeek (NL); Albertus Jacobus Maria Bouwman, Groessen (NL); Hisham Nasr-El-Din, College Station, TX (US)

(72) Inventors: Cornelia Adriana De Wolf, Eerbeek (NL); Albertus Jacobus Maria Bouwman, Groessen (NL); Hisham Nasr-El-Din, College Station, TX (US)

(73) Assignee: AKZO NOBEL CHEMICALS INTERNATIONAL B.V., Amersfoort (NL)

(21) Appl. No.: 14/125,102

(22) PCT Filed: Jun. 11, 2012
(86) PCT No.: PCT/EP2012/060952

§ 371 Date: Dec. 10, 2013

Related U.S. Application Data
(60) Provisional application No. 61/496,236, filed on Jun. 13, 2011.

(30) Foreign Application Priority Data
Jul. 6, 2011 (EP) 11172815.0
Dec. 14, 2011 (EP) 2011/072693
Dec. 14, 2011 (EP) 2011/072696
Dec. 16, 2011 (EP) 2011/073042

(51) Int. Cl. C09K 8/54

(52) U.S. Cl. CPC C09K 8/54
USPC 428/34.1; 422/7; 510/188; 507/241

(57) ABSTRACT

The present invention relates to process to reduce the corrosion of equipment containing a chromium-containing alloy in the oil and/or gas industry, comprising a step of contacting the equipment based on a chromium-containing alloy with a solution containing at least 1 wt % on total weight of the solution of glutamic acid N,N-diacetic acid or a salt thereof (GLDA) and/or methylglycine N,N-diacetic acid or a salt thereof (MGDA) having an acidic pH, the use of the above solutions in equipment containing a chromium-containing alloy to reduce corrosion, and to a system containing a piece of equipment used in the oil and/or gas industry made at least partly from chromium-containing alloy in contact with an acidic solution containing at least 1 wt % of glutamic acid N,N-di acetic acid or a salt thereof (GLDA) and/or methylglycine N,N-di acetic acid or a salt thereof (MGDA).

The present invention relates to a method to reduce the corrosion of chromium-containing equipment in the oil and/or gas industry. The invention also relates to the use of solutions containing glutamic acid N,N-diacetic acid or a salt thereof (GLDA) and/or methylglycine N,N-diacetic acid or a salt thereof (MGDA) having an acidic pH that are contacted with chromium-containing equipment in the oil and/or gas industry, for example to clean or descale such equipment or downstream equipment, but also as a chemical in such equipment, for example as a chemical in an oil and/or gas downstream processing plant or factory that contains chromium-containing tanks, boilers, tubes or other equipment. Finally, the invention relates to equipment made from a chromium-containing alloy containing a solution containing glutamic acid N,N-diacetic acid or a salt thereof (GLDA) and/or methylglycine N,N-diacetic acid or a salt thereof (MGDA) having an acidic pH or to a combined system that contains equipment made from a chromium-containing alloy in contact with a solution containing glutamic acid N,N-diacetic acid or a salt thereof (GLDA) and/or methylglycine N,N-diacetic acid or a salt thereof (MGDA) having an acidic pH.

More in particular, the present invention relates to any of the above methods, equipment or systems wherein compared to the state of the art the use of a corrosion inhibitor can be greatly reduced or in some cases even omitted.

In many industrial environments, like plants, factories, but also in oil and gas production installations, a large part of the equipment, such as tubes, tanks, boilers, reactor vessels, is made from chromium-containing metal alloys. Also, a lot of chromium is applied in oil platforms. This is because chromium-containing alloys have a better resistance against oxidative degradation than many other metals and alloys. However, under the influence of both oxygen and carbon dioxide and a number of other corrosive chemicals, like chloride-containing chemicals, chromium-containing alloys also suffer negative degradation and corrosion effects, especially at an elevated temperature.

Hence, there has been a continued search for processes to apply, clean, and descale equipment used in the oil and/or gas industry and for chemicals that do not have the above problems when contacted with chromium-containing alloys to replace previously used chemicals.

Many documents disclose the use of alkaline solutions containing a chelating agent as detergent solutions, also to clean metal surfaces. It should be noted that corrosion means gradual destruction of the metal by chemical reaction with its environment, namely oxidation of metals in reaction with an oxidant such as oxygen. As such, corrosion is distinctly different from fouling and descaling, which relate to cleaning a deposit from the metal surface and not preventing degradation of the metal itself or the effects thereof. For example, EP 1 067 172, JP 11158492, WO 2004/013055, and US 2009/0298738 disclose alkaline cleaning solutions containing a chelating agent in the sense of removing scale, grease, oil and/or fouling. It is said in EP 1067172 that the corrosive effect on light metals is low, with the light metal specified being alumina.

However, acids especially are known to cause undesired corrosion of metal surfaces, as is seen in for example the oil industry where the use of acidic solutions or gases like CO₂ is common practice and where naturally occurring corrosive gases like H₂5 and CO₂ can be present.

In this respect, S. Al-Harthy et al., in “Options for High-Temperature Well Stimulation,” Oilfield Review Winter 2008/2009, 20, No. 4, Schlumberger disclose that the use of N-hydroxyethyl ethylenediamine N,N′,N′-triacetic acid has much lower undesired corrosion side effects than do a number of other chemicals playing a role in the oil field, where the use of chromium steel is common practice.

The purpose of this invention is to provide new chemicals and solutions that give an even more minimized chromium corrosion side effect as well as a reduced corrosion effect in the acidic pH range, and to provide processes to apply, clean or descale chromium-containing equipment as used in the oil and/or gas industry or to run a number of chemical processes wherein chromium corrosion is minimized, under varying temperature and acidic pH conditions.

US 2010/0078040 discloses removing rouging on stainless steel surfaces, for example from equipment used in the pharmaceutical industry, by using aqueous cleaning solutions that contain at least two different complexing agents in the neutral pH range. The complexing agents can be picked from a large group of compounds that includes GLDA and MGDA. In the examples a cleaning solution is made containing about 9 wt % of MGDA, but when using this solution to clean a vessel a 50 fold dilution is made, so that the vessel is only contacted with a solution containing less than 0.2 wt % of MGDA. Nor is a high amount of the complexing agent used anywhere in the other examples.

The present invention relates to preventing or reducing corrosion in the oil and/or gas industry, where generally much more concentrated chemical solutions are applied because in this industry using large amounts of water is not always economically feasible, as water is often unavailable at the oil or gas production site, especially when the use of seawater is not an option due to the interaction of seawater components with the formation, equipment or other production chemicals resulting in more corrosion and/or unwanted precipitation. In addition, the application of low concentrations reduces the reaction rate considerably, resulting in long and costly downtimes.

It has now been found that relatively concentrated solutions of glutamic acid N,N-diacetic acid or a salt thereof (GLDA) and of methylglycine N,N-diacetic acid or a salt thereof (MGDA) having an acidic pH give a surprisingly and significantly lower corrosion of chromium-containing alloys than other chelating agent-containing and/or acidic solutions, over the acidic pH and a broad temperature range.

Accordingly, the present invention provides alternative processes and systems that can replace state of the art processes in the oil and/or gas industry and systems that suffer from negative corrosion effects.

The present invention provides a process to reduce the corrosion of equipment containing a chromium-containing alloy in the oil and/or gas industry, comprising a step of contacting the equipment containing a chromium-containing alloy with a solution containing at least 1 wt % on total weight of the solution of glutamic acid N,N-diacetic acid or a salt thereof (GLDA) and/or methylglycine N,N-diacetic acid or a salt thereof (MGDA) having an acidic pH, and more specifically a process to reduce the corrosion of equipment containing a chromium-containing alloy in the treatment of a subterranean formation wherein an acidic solution is introduced into the formation and at least part of the acid in the acidic solution is GLDA and/or MGDA, preferably wherein the amount of GLDA and/or MGDA is at least 1 wt % on the basis of the acidic solution, and the acidic solution comes into contact with the equipment containing a chromium-containing alloy.

The invention also relates to the use of acidic solutions containing at least 1 wt % on total weight of the solution of glutamic acid N,N-diacetic acid or a salt thereof (GLDA) and/or methylglycine N,N-diacetic acid or a salt thereof (MGDA) to prevent or reduce corrosion in equipment containing a chromium-containing alloy in the oil and/or gas industry, for example to clean or descale such equipment, but also as a chemical in chromium-containing equipment, for example as a chemical in a plant or factory in the oil and/or gas industry that contains chromium-containing tanks, boilers, tubes or other equipment, replacing other chemicals, in treatments of subterranean formations like in completions and stimulation by acidizing, fracturing, and descaling. Chemicals that can be replaced by GLDA or MGDA are chelating agents in their acidic form but also other acids, because it is possible to make concentrated acidic solutions of MGDA and even more concentrated, more acidic solutions of GLDA.

The present invention also provides a system containing a piece of equipment applied in the oil and/or gas industry made at least partly from a chromium-containing alloy in contact with an acidic solution containing at least 1 wt % on total weight of the solution of glutamic acid N,N-diacetic acid or a salt thereof (GLDA) and/or methylglycine N,N-diacetic acid or a salt thereof (MGDA). The system of the invention in embodiments contains further improved chelating agent-containing and acidic solutions, such as solutions used in the oil field, gas field, or oil and/or gas downstream processing industry in addition containing other components like a solvent such as water, a chelating agent, a surfactant, and a corrosion inhibitor, wherein the amount of corrosion inhibitor can be greatly decreased or even omitted.

It should be noted that WO 2008/0103551 discloses an acidic solution containing a chelating agent and the use thereof as a breaker fluid in the oil field. The chelating agent may be GLDA. However, this document only discloses the circulation of the solution in a wellbore and does not disclose the combination of this solution with any chromium-containing equipment and therefore neither discloses nor suggests any benefits in preventing or reducing corrosion.

The equipment containing a chromium-containing alloy may be for example a pump, tap, tube, tank, vessel, or pipe or any other device that can hold a solution or through which a solution can flow. The chromium-containing alloy may be present in the whole piece of equipment but also only in a sheet or plate or a part of the piece of equipment in any other form (like for example a screw or nail) as used in the oil industry and/or gas industry.

By the term acidic solution or solution having an acidic pH is meant a solution having a pH of below 7, preferably a pH below 6, and even more preferably below 5. The pH in some embodiments is higher than −2, preferably higher than −1, and more preferably higher than 0.

By use or application in the oil and/or gas industry is meant any use in the production, exploration and/or recovery of oil and/or gas from subterranean formations, transporting the oil and/or gas to downstream processing units such as oil refinery and/or oil and/or gas downstream processing units, processing the oil and/or gas in such units, and all accompanying processes and uses such as the cleaning, descaling, and maintenance of the equipment, removing small particles and removing scale to enhance oil and/or gas well performance and cleaning of the wellbore.

Any use according to the invention involves a step wherein the solution containing GLDA and/or MGDA contacts equipment containing a chromium-containing alloy.

The acidic solution containing GLDA and/or MGDA in one embodiment may contain other components, such as primarily water, but also other solvents like alcohols, glycols, and further organic solvents or mutual solvents, soaps, surfactants, dispersants, emulsifiers, pH control additives, such as further acids or bases, biocides/bactericides, water softeners, bleaching agents, enzymes, brighteners, fragrances, antifouling agents, antifoaming agents, anti-sludge agents, corrosion inhibitors, corrosion inhibitor intensifiers, viscosifiers, wetting agents, diverting agents, oxygen scavengers, carrier fluids, fluid loss additives, friction reducers, stabilizers, rheology modifiers, gelling agents, scale inhibitors, breakers, salts, brines, particulates, crosslinkers, salt substitutes, relative permeability modifiers, sulfide scavengers, fibres, nanoparticles.

In addition to it being found that the use of cationic surfactants, as is common practice in the oil and/or gas industry, can already decrease the undesired corrosivity of fluids in the oil and gas industry, it has now been found that GLDA and MGDA give an even lower corrosion of chromium-containing alloys than HEDTA, especially in the relevant acidic pH range, in the case of GLDA even below the industry limit value of 0.05 lbs/sq.ft (for a 6-hour test period), without the addition of any corrosion inhibitors. Accordingly, MGDA and/or GLDA give an unexpectedly reduced chromium corrosion side effect, and the use thereof in a subterranean formation treatment process results in corrosion of the chromium-containing equipment being significantly prevented and an improved process to clean and/or descale chromium-containing equipment. Also because of the above beneficial effect, the invention covers a method using a solution in which the amount of corrosion inhibitor and corrosion inhibitor intensifier can be greatly reduced compared to the state of the art fluids and processes, while still avoiding corrosion problems in the equipment.

In the solutions of this invention the amount of GLDA and/or MGDA is suitably between 2 and 50 wt % for GLDA and between 2 and 40 wt % for MGDA. Preferably, the amount is between 2 and 30 wt %, more preferably 5 and 30 wt %, even more preferably between 5 and 20 wt % on the basis of the total weight of the solution. The solutions of the invention preferably contain GLDA.

The solutions may be used at several temperature ranges, suitably between 0 and 200° C., preferably between 20 and 150° C., even more preferably between 20 and 100° C.

The surfactant that can be used in the present invention can be any surfactant known in the art and can be nonionic, cationic, anionic, zwitterionic. When the formation to be treated is a carbonate formation, preferably, the surfactant is nonionic or cationic and even more preferably, the surfactant is cationic. When the formation is a sandstone formation, preferably, the surfactant is nonionic or anionic, and even more preferably the surfactant is anionic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides and the like, and mixtures thereof. Alkoxylated alcohols, preferably ethoxylated alcohols, optionally in combination with (alkyl)polyglycosides, are the most preferred nonionic surfactants.

The anionic (sometimes zwitterionic, as two charges are combined into one compound) surfactants may comprise any number of different compounds, including sulfonates, hydrolyzed keratin, sulfosuccinates, taurates, betaines, modified betaines, alkylamidobetaines (e.g., cocoamidopropyl betaine).

The cationic surfactants may comprise quaternary ammonium compounds (e.g., trimethyl tallow ammonium chloride, trimethyl cocoammonium chloride), derivatives thereof, and combinations thereof.

Examples of surfactants that are also foaming agents that may be utilized to foam and stabilize the solutions of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

Suitable surfactants may be used in a liquid or powder form.

Where used, the surfactants may be present in the solutions in an amount sufficient to prevent incompatibility with formation fluids, other treatment fluids, or wellbore fluids at reservoir temperature.

In an embodiment where liquid surfactants are used, the surfactants are generally present in an amount in the range of from about 0.01% to about 5.0% by volume of the solution.

In one embodiment, the liquid surfactants are present in an amount in the range of from about 0.1% to about 2.0% by volume of the solution, preferably from 0.1 to 1.0 volume %.

In embodiments where powdered surfactants are used, the surfactants may be present in an amount in the range of from about 0.001% to about 0.5% by weight of the solution.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds) and a sulfur compound. The amount of corrosion inhibitor is preferably less than 2.0 volume %, more preferably between 0.001 and 1.0 volume % on total solution.

Preferably, the chromium-containing alloy contains a stainless steel or another metal alloy in which chromium is present, which is often to improve the corrosion properties thereof. In a preferred embodiment the chromium-containing alloy contains between 1 and 40 wt % of chromium on total metal content, more preferably it contains between 5 and 30 wt % of chromium, even more preferably between 10 and 25 wt % of chromium. Preferably, the chromium-containing alloy contains stainless steel.

Examples of chromium-containing stainless steels are (i) austenitic steels, which contain a maximum of 0.15% carbon, a minimum of 16% chromium, and sufficient nickel and/or manganese to retain an austenitic structure at all temperatures from the cryogenic region to the melting point of the alloy, wherein a typical composition of 18% chromium and 10% nickel is often used in flatware; (ii) superaustenitic stainless steels, which exhibit great resistance to chloride pitting and crevice corrosion due to a high molybdenum content (>6%) and nitrogen additions, and which by a higher nickel content ensure better resistance to stress-corrosion cracking versus the 300 series; (iii) ferritic stainless steels, which generally have better engineering properties than austenitic grades but reduced corrosion resistance due to the lower chromium and nickel content, which contain between 10.5% and 27% chromium and very little nickel, if any, although some types can contain lead, and wherein many compositions include molybdenum and some include aluminium or titanium, (iv) martensitic stainless steels, which are not as corrosion-resistant as the other two classes but are extremely strong and tough, as well as highly machinable, and which can be hardened by heat treatment, which steels contain chromium (12-14%), molybdenum (0.2-1%), nickel (less than 2%), and carbon (about 0.1-1%) (giving the material more hardness but also making it a bit more brittle); (v) precipitation-hardening martensitic stainless steels, which have a corrosion resistance comparable to austenitic varieties but can be precipitation-hardened to even higher strengths than the other martensitic grades; (vi) Duplex stainless steels, which have a mixed microstructure of austenite and ferrite, the aim usually being to produce a 50/50 mix, although in commercial alloys the ratio may be 40/60, which steels have roughly twice the strength compared to austenitic stainless steels and also improved resistance to localized corrosion, particularly pitting, crevice corrosion, and stress corrosion cracking and are characterized by high chromium (19-32%) and molybdenum (up to 5%) and lower nickel contents than austenitic stainless steels

Experimental

### EXAMPLE 1

A beaker glass was filled with 400 ml of a solution of a chelating agent as indicated in Table 1 below, i.e. about 20 wt % of the sodium salt of about pH 3.6. This beaker was placed in a Burton Corblin 1-liter autoclave.

The space between the beaker and the autoclave was filled with sand. Two clean steel coupons of Cr-13 (UNS S41000 steel) were attached to the autoclave lid with a PTFE cord. The coupons were cleaned with isopropyl alcohol and weighted before the test. The autoclave was purged three times with a small amount of N₂. Subsequently the heating was started or in the case of high pressure experiments the pressure was first set to c. 1,000 psi with N₂. The 6-hour timer was started directly after reaching a temperature of 149° C. After 6 hours at 149° C. the autoclave was cooled quickly with cold tap water in c. 10 minutes to <60° C. After cooling to <60° C. the autoclave was depressurized and the steel coupons were removed from the chelate solution. The coupons were gently cleaned with a non-metallic brush and flushed with a small amount of water and isopropyl alcohol. The coupons were weighted again and the chelate solution was retained.

TABLE 1
Acid/Chelate solutions:

| | Active ingredient and | pH as |
|---|---|---|
| Chelate | Content | such |
| GLDA | 20.4 wt % GLDA-NaH₃ | 3.51 |
| HEDTA | 22.1 wt % HEDTA-NaH₂ | 3.67 |
| MGDA | 20.5 wt % MGDA-NaH₂ | 3.80 |

Results

In the scheme of Table 2 the results of the corrosion study of Cr-13 steel coupons (UNS S41000) are shown for the different solutions.

TABLE 2
Different chelate or acid solutions

| | | | | | | 6 Hrs |
|---|---|---|---|---|---|---|
| Test | | | Temp. | Pressure | Assay after | corrosion |
| no. | Chelate | pH | ° C. | (PSI) | corrosion test | LBS/sq.ft |
| #01 | GLDA | 3.5 | 160 | — | 18.4 wt % as | 0.0013 |
| | | | | | GLDA-NaH₃ | |
| #02 | GLDA | 3.5 | 149 | — | 20.1 wt % as | 0.0008 |
| | | | | | GLDA-NaH₃ | |
| #03 | HEDTA | 3.7 | 149 | — | 24.4 wt % as | 0.3228 |
| | | | | | HEDTA-NaH₂ | |
| #04 | GLDA | 3.5 | 149 | >1000 | 20.1 wt % as | 0.0009 |
| | | | | | GLDA-NaH₃ | |
| #05 | HEDTA | 3.7 | 149 | >1000 | 16.0 wt % as | 0.5124 |
| | | | | | HEDTA-NaH₂ | |
| #06 | MGDA | 3.6 | 149 | >1000 | 22.7 wt % as | 0.0878 |
| | | | | | MGDA-NaH₂ | |

The corrosion rates of HEDTA (pH 3.7) at 149° C. and pressure of 1,000 psi are significantly higher than for MGDA (pH 3.8) and much higher compared to GLDA (pH 3.5). The corrosion rates of both HEDTA (pH 3.7) and MGDA (pH 3.8) at 149° C. and pressure of 1,000 psi are higher than the generally accepted limit value in the oil and gas industry for chromium based alloys of 0.03 LBS/sq.ft (6 hours test period), which means that they will need a corrosion inhibitor for use in this industry. As MGDA is significantly better than HEDTA, it will require a much decreased amount of corrosion inhibitor for acceptable use in the above applications when used in line with the conditions of this Example. The 6-hour corrosion of GLDA for Cr-13 steel (stainless steel S410, UNS S41000) at 149° C. (300° F.) is well below the generally accepted limit value in the oil and gas industry of 0.03 LBS/sq.ft. It can thus be concluded that it is possible to use GLDA in this field without the need to add a corrosion inhibitor.

### EXAMPLE 2

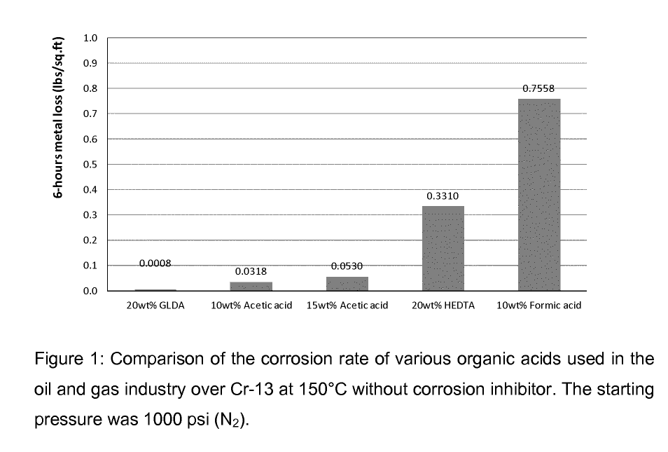

In FIG. 1 the corrosion rate of 20 wt % GLDA at 150° C. was compared with other frequently used acids in the oil and gas industry for Cr-13 steel. The corrosion tests were performed according to the procedure described in Example 1. Without any addition of corrosion inhibitor the corrosion caused by 10 wt % acetic acid, 15 wt % acetic acid, 20 wt % HEDTA at pH=3.8, and 10 wt % formic acid is above the generally accepted limit for chromium-containing alloys of 0.03 LBS/sq.ft during a 6 hr test. The corrosion caused by 20 wt % GLDA at pH=3.8 is far below this limit, i.e. 0.008 LBS/sq.ft.

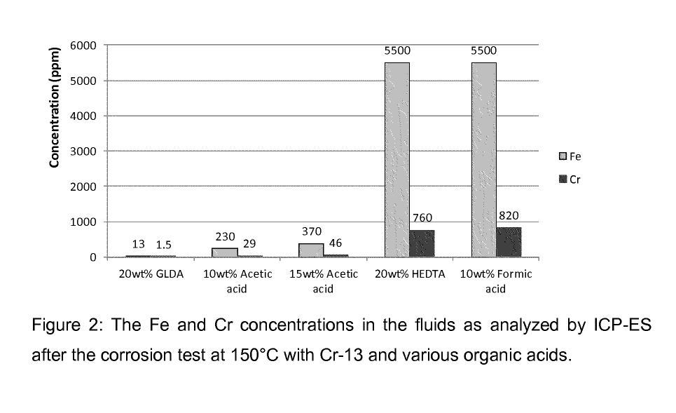

FIG. 2 shows the ICP-ES element analysis of the corrosion fluids after the 6 hr corrosion test at 150° C. The analysis shows that 20 wt % HEDTA at pH=3.8 and 10 wt % formic acid attack the iron and chromium ions in the stainless steel to the same extent, resulting in high concentrations of these elements. It was even observed that the colour of the HEDTA fluid turned from pale yellow before the corrosion test to dark purple after the test. The colour of Cr-HEDTA is purple. The acetic acids cause a smaller increase in iron and chromium ions in line with the lower corrosion rate. The 20 wt % GLDA solution at pH=3.8 caused a negligible increase in iron and chromium in the solution, indicating that GLDA does not cause any corrosion on Cr-13 steel under these conditions.

### EXAMPLE 3

Corrosion tests with anionic surfactants and/or corrosion inhibitors were performed with Cr-13 steel according to the method described in Example 1. The surfactant, Witconate NAS-8, was selected from the group of anionic water-wetting surfactants. Witconate NAS-8 consists of 36% 1-octanesulfonic acid, sodium salt, 60% water, and 4% sodium sulfate. Armohib 31 represents a group of widely used corrosion inhibitors for the oil and gas industry and consists of alkoxylated fatty amine salts, alkoxylated organic acid, and N,N′-dibutyl thiourea, with 100% active ingredients. The corrosion inhibitor and anionic surfactant are available from AkzoNobel Surface Chemistry.

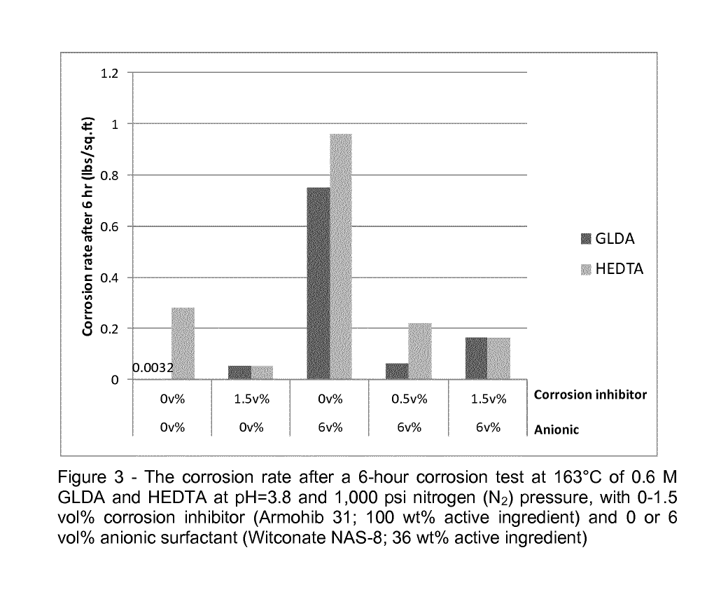

FIG. 3 clearly shows the difference in corrosion behaviour between GLDA and HEDTA. Without additives GLDA shows no corrosion, whereas the corrosion rate of HEDTA is 0.2787 lbs/sq. ft, which is far above the generally accepted limit of 0.05 lbs/sq ft. Upon addition of the corrosion inhibitor the corrosion rates of HEDTA and GLDA are similar. Addition of an anionic surfactant leads to an increase in the corrosion rate to unacceptable rates of 0.7490 lbs/sq.ft for GLDA and 0.9592 lbs/sq.ft for HEDTA, indicating the corrosive character of this anionic surfactant itself. When both 0.5 vol % corrosion inhibitor and 6 vol % anionic surfactant are combined with HEDTA, the corrosion rate is reduced to 0.2207 lbs/sq. ft, which is still far too much. In contrast, the corrosion rate of GLDA decreases to acceptable rates under identical conditions, indicating the surprisingly gentle character of GLDA for this metallurgy. Even when the amount of corrosion inhibitor is increased to 1.5 vol %, the corrosion rate of HEDTA is still 3 times more than the acceptable rate. For GLDA the corrosion rate increases when the amount of corrosion inhibitor is increased to 1.5 vol %, indicating that the optimum corrosion inhibitor concentration under these conditions is around 0.5 vol %, which is significantly lower than the amount required for HEDTA.

### EXAMPLE 4

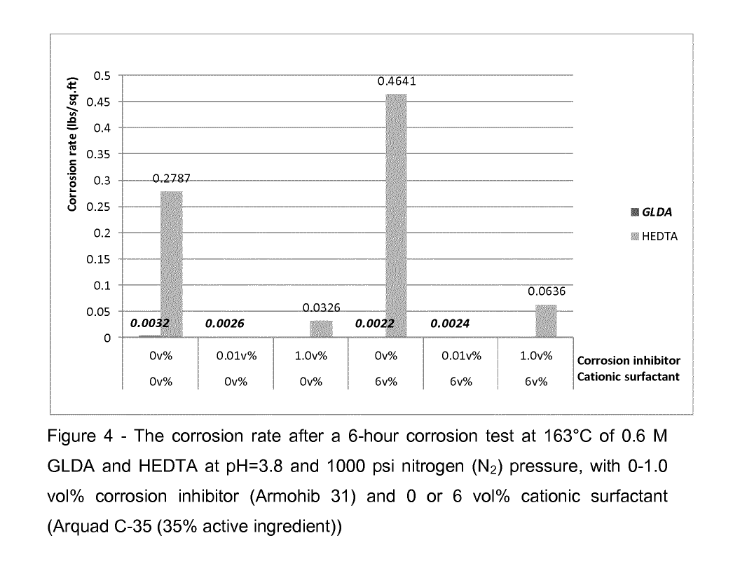

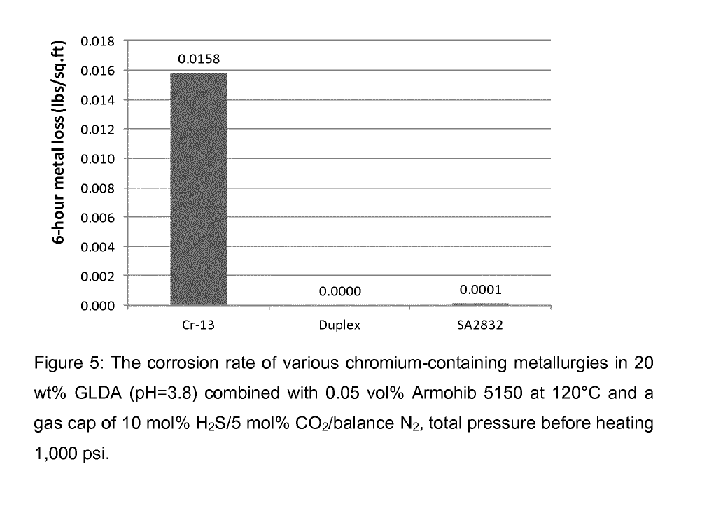

To study the effect of the combination of a corrosion inhibitor, cationic surfactant, and GLDA on the corrosion of Cr-13 steel (UNS S41000), a series of corrosion tests were performed using the method described in Example 1. The results expressed as the 6-hour metal loss at 163° C. are shown in FIG. 4. The cationic surfactant, Arquad C-35, consists of 35% cocotrimethyl ammonium chloride and water. Armohib 31 represents a group of widely used corrosion inhibitors for the oil and gas industry and consists of alkoxylated fatty amine salts, alkoxylated organic acid, and N,N′-dibutyl thiourea. The corrosion inhibitor and cationic surfactant are available from AkzoNobel Surface Chemistry.

The results show that the corrosion rate of GLDA is significantly less than for HEDTA under all studied conditions. In combination with 0.01 vol % of corrosion inhibitor and/or 6 vol % of cationic surfactant the corrosion rate of GLDA remains well below the acceptable limit of 0.05 lbs/sq.ft. Even in the absence of corrosion inhibitor acceptable results were obtained for this type of metallurgy, but for inferior quality metal types a minor amount of corrosion inhibitor is expected to be needed. For HEDTA 1.0 vol % corrosion inhibitor is not yet sufficient to reduce the corrosion rate below this limit. The results show that, in contrast to HEDTA, GLDA is surprisingly gentle to Cr-13 metal and that combining GLDA with corrosion inhibitor or cationic surfactant or not does not influence the corrosion rate.

### EXAMPLE 5

Corrosion tests were executed according to the method described in Example 1 with various types of chromium containing alloys. The composition of the metals is given in Table 3. Under conditions that are typical for the North Sea area, i.e. 120° C. and in the presence of 10 mol % H₂S/5 mol % CO₂/balance N₂, a 20 wt % GLDA solution at pH=3.8 required only a minimum quantity of 0.05 v% corrosion inhibitor (Armohib 5150, available from AkzoNobel) to stay below the industry limit of 0.03 lbs/sq.ft for these types of alloys, which is far below the normal corrosion inhibitor loadings used under these conditions during acid treatments.

TABLE 3
Composition of the steel coupons

| | Cr-13 | Duplex 2205 | SA2832 |
|---|---|---|---|
| Element | (S41000) | (S31803) | (N08028) |
| C | 0.13 | 0.017 | 0.008 |
| Mn | 0.39 | 1.43 | 1.5 |
| Si | 0.4 | 0.36 | 0.3 |
| Cu | 0.1 | 0.31 | 1.21 |
| Ni | 0.3 | 3.71 | 30.65 |
| Cr | 12.2 | 22.42 | 26.75 |
| Mo | 0.03 | 3.18 | 3.46 |
| Fe | balance | Balance | balance |

1. A process to reduce the corrosion of equipment containing a chromium-containing alloy in the oil and/or gas industry, comprising a step of contacting the equipment containing a chromium-containing alloy with a solution containing between 2 and 50 wt % on total weight of the solution of glutamic acid N,N-diacetic acid or a salt thereof (GLDA) and/or between 2 and 40 wt % methylglycine N,N-diacetic acid or a salt thereof (MGDA) having an acidic pH.

2. A process to reduce the corrosion of equipment containing a chromium-containing alloy in the treatment of a subterranean formation wherein an acidic solution is introduced into the formation and at least part of the acid in the acidic solution is glutamic acid N,N-diacetic acid or a salt thereof (GLDA) and/or methylglycine N,N-diacetic acid or a salt thereof (MGDA), and the acidic solution comes into contact with the equipment containing a chromium-containing alloy.

3. The process of claim 2 wherein the amount of GLDA and/or MGDA is at least 1 wt % on total weight of the solution.

4. A process for preventing or reducing corrosion in equipment containing a chromium-containing alloy in the oil and/or gas industry, comprising using acidic solutions containing between 2 and 50 wt % on total weight of the solution of glutamic acid N,N-diacetic acid or a salt thereof (GLDA) and/or between 2 and 40 wt % methylglycine N,N-diacetic acid or a salt thereof (MGDA).

5. The process of claim 4 wherein the acidic solution is used to clean or descale the equipment.

6. The process of claim 4 wherein the acidic solution is used to treat a subterranean formation to produce oil and/or gas therefrom.

7. (canceled)

8. The process of claim 4 wherein the acidic solution is used in oil and/or gas production in completions and stimulation by acidizing, or fracturing.

9. The process of claim 4 wherein the solution contains water, a surfactant, an acid and/or a corrosion inhibitor.

10. The process of claim 4 wherein the solution contains one or more additives selected from the group consisting of solvents, like water, alcohols, glycols, organic solvents, mutual solvents, soaps, surfactants, dispersants, emulsifiers, pH control additives, acids, bases, biocides/bactericides, water softeners, bleaching agents, enzymes, brighteners, fragrances, antifouling agents, antifoaming agents, anti-sludge agents, corrosion inhibitors, corrosion inhibitor intensifiers, viscosifiers, wetting agents, diverting agents, oxygen scavengers, carrier fluids, fluid loss additives, friction reducers, stabilizers, rheology modifiers, gelling agents, scale inhibitors, breakers, salts, brines, particulates, crosslinkers, salt substitutes, relative permeability modifiers, sulfide scavengers, fibres, and nanoparticles.

11. A system containing a piece of equipment applied in the oil and/or gas industry made at least partly from a chromium-containing alloy in contact with an acidic solution containing between 2 and 50 wt % on total weight of the solution of glutamic acid N,N-diacetic acid or a salt thereof (GLDA) and/or between 2 and 40 wt % methylglycine N,N-diacetic acid or a salt thereof (MGDA).

12. The system of claim 11 wherein the solution contains water, a surfactant, an acid and/or a corrosion inhibitor.

13. The system of claim 11 wherein the piece of equipment is a pump, tap, tube, tank, container, vessel, pipe or a device that holds or contains the solution or through which the solution flows.

14. The system of claim 11 wherein the chromium-containing alloy contains a stainless steel comprising 5 to 30 wt % of chromium on total metal content.

15. The system of claim 14 wherein the stainless steel is selected from the group consisting of austenitic stainless steels, superaustenitic stainless steels, ferritic stainless steels, martensitic stainless steels, precipitation-hardening martensitic stainless steels, and Duplex stainless steels.
